(19) United States
(12) Patent Application Publication
(10) Pub. No.: US 2008/0060620 A1
(43) Pub. Date: Mar. 13, 2008

(54) Diesel engine conversion to use alternative fuels

(76) Inventor: Brian Friedman, Los Angeles, CA (US)

Correspondence Address: Lawrence S. Cohen, Suit 1220, 10960 Wilshire Blvd., Los Angeles, CA, 90024, US

(21) Appl. No.: 11/518,371

(22) Filed: Sep. 8, 2006

(51) Int. Cl. F02G 5/00

(52) U.S. Cl. 123/557

(57) ABSTRACT

A method and apparatus for converting a diesel engine for running on alternative fuels in which the a fuel heater is attached to the stock filter mount and the stock fuel-in and stock fuel-out lines of the stock filter mount carry fuel into the fuel heater and out of it.

### FIELD OF THE INVENTION

The invention relates to conversion apparatus and methods to allow diesel engines to run with alternative fuels.

### BACKGROUND OF THE INVENTION

Concern about the price and availability of automotive fuel and is ubiquitous. It is possible to convert diesel engines to run on alternative fuels.

Numerous techniques and variations have been developed for such conversions.

Common features of conversion technology address the characteristics of vegetable oils as alternative fuels that differ from diesel oil. Basic recognized general elements for the use of alternative fuels are heating the alternative fuel and filtering. Various approaches to these issues have been implemented.

Heating addresses an important aspect of conversions which is the need to lower the viscosity of the alternative fuel as close as possible to that of diesel fuel. This is done by heating the alternative fuel. In the case of vegetable oil, it is considered that it must be at, at least about 160 degrees ° C. at the point that it is introduced to the injector pump in order that its viscosity be at or near that of diesel fuel.

Prior art devices accomplish this by directing the fuel to a heater just before it is introduced into the injector pump. This approach to addressing the heating issue creates a considerable problem in trying to locate the heater close to the injector pump. It involves the need to attach the heater somewhere where it will be secure, but close to the engine. There are two basic sources of heat. One is hot engine coolant and the other is electrical heating. Each presents problems of its use to heat the alternative fuel. Providing a heater also involves re-routing the fuel lines. Both of these issues, heating and filtering, are problematic to the conversion.

FIG. 1 shows in schematic form the general layout of a stock diesel engine The term “stock” as used herein means a mechanical item as it is present in an unconverted diesel engine; and usually as original equipment, which is also referred to as OEM equipment. In FIG. 1, the following equipment is shown:
Fuel tank, 10,
Fuel return line, 12,
Fuel line to engine, 14,
Heater core, 16,
Heater hose, 18,
Heater hose, 20,
Engine, 22,
Fuel Injectors (5), 24,
Fuel lines from injector pump, 26,
Injector pump, 28,
Fuel filter and filter mount, 30,
Radiator hose, 32,
Radiator hose, 34,
Water pump, 36,
Radiator, 38.

FIGS. 1 and 2 show one design for a heater 40 to be installed near the injector pump in which a heating coil 42 has concentric tubing to provide an inner line 44 for engine coolant and an outer line 46 for fuel. The inner line 44 is attached by fittings 48 to the incoming and exiting coolant lines 50 and 52 respectively and the outer line 46 is attached by fittings 54 and 56 to incoming and outgoing fuel lines 58 and 60 respectively. In operation as fuel flows through the outer line 46 it is heated by engine coolant flowing through the inner line 44. It is recognized that this rather bulky part requires attachment to the coolant system and mounting parts. This requires that fuel liens be rerouted. Since automobiles are designed differently mounting parts vary with the vehicle design.

There is a need for a more economical and easier to install means for heating fuel in a diesel engine conversion.

### SUMMARY OF THE INVENTION

The invention resides in eliminating the stock filter and substituting in its place using the stock filter mount, a heat exchanger with a fuel heating chamber for fuel to be passed through which chamber is exposed to a heat source so that the fuel that passes through the fuel heating chamber is heated and then flows to the injector pump. This takes advantage of the fact that the stock filter and filter mount are in a place quite close to the engine so that the heating is done close to the engine and eliminates the need for awkward mounting of a fuel heater. It saves a great deal of extra routing of the fuel lines, and providing mounting elements for an auxiliary heater. A substitute filter is employed which in any event is needed to satisfy the filtering needs for the alternative fuels.

### BRIEF DESCRIPTION OF THE DRAWINGS

FIG. 1 is a generic schematic view of a standard diesel engine of the prior art.

FIG. 2 is a prior art fuel heater.

FIG. 3 is detail of the fuel heater of FIG. 2.

FIG. 4 is a generic schematic view of a converted diesel engine system in which the present invention is implemented.

FIG. 5 is a perspective view of an embodiment of the present invention.

FIG. 6 is an exploded view of the embodiment of FIG. 5.

FIG. 7 is a section view through A-A of FIG. 4.

FIG. 8 is alternative embodiment of the invention.

FIG. 9 is another alternative embodiment of the invention.

FIG. 10 is prospective view of the fuel heating chamber of the invention.

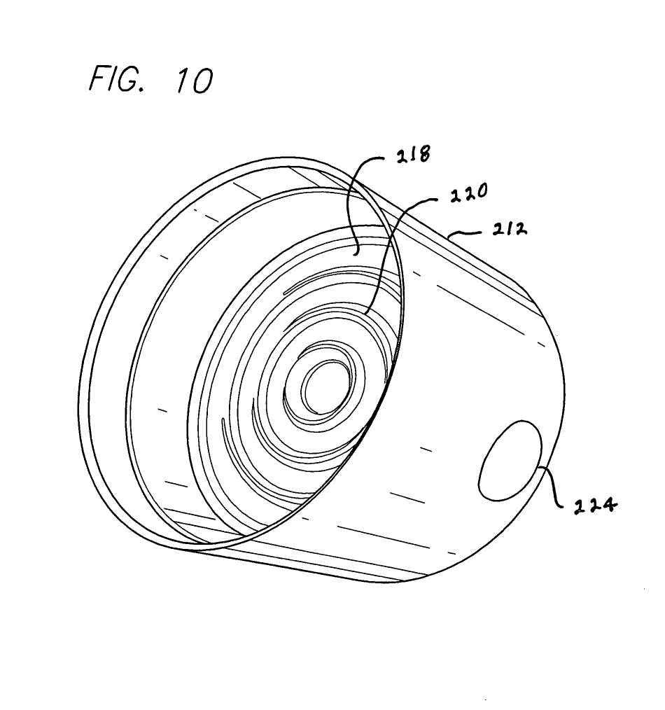

### DETAILED DESCRIPTION

The invention resides in steps and devices for conditioning alternative fuels for use in diesel engines. In one embodiment the invention is provided as a kit that can be installed in a diesel engine equipped vehicle. A feature of the present invention resides in treating the alternative fuel to run on an engine that has no, or very little need for converting engine components such as injectors.

The invention avoids the problem of rerouting fuel lines to bypass the stock filter mount, and it eliminates the problem of finding a way to mount a heater near the injector pump and performing the heating near the injector pump and the problem of rerouting fuel lines to connect to a heater.

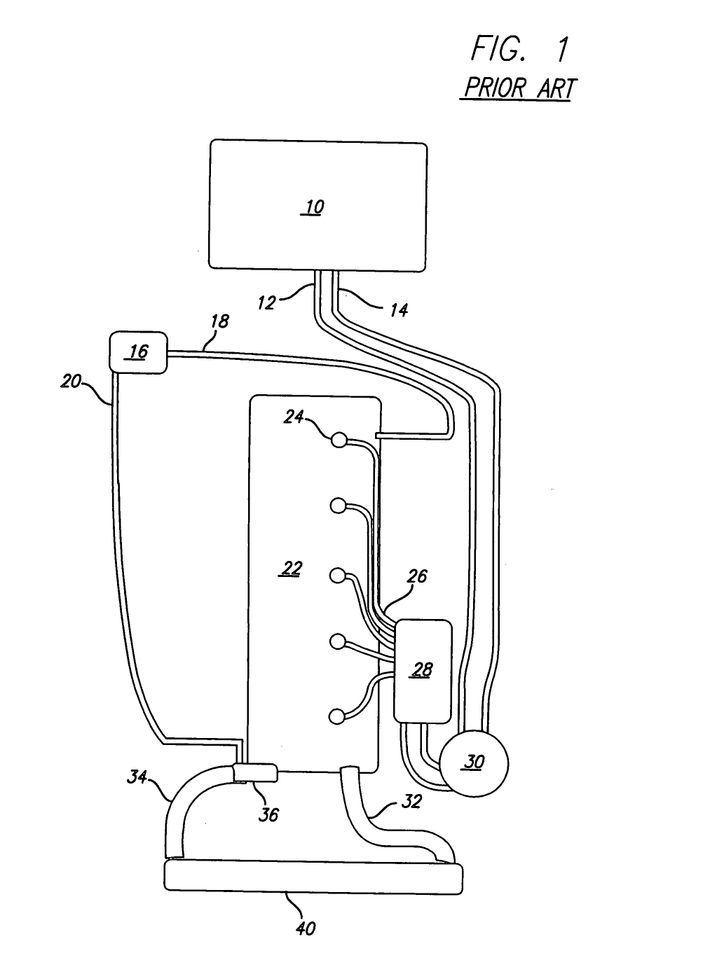

FIG. 1 is a generic prior art diesel engine having a fuel tank 10, a fuel line to the engine 14, a fuel return line 12, a fuel filter 30, an injection pump 28, fuel lines to the injectors 26, injectors 24, the engine 22, a heater core 16, a heater hose 18, a heater hose 20, a water pump 36, a radiator hose 34, a radiator 40, and radiator hose 32. It will be unnecessary to describe the operation of a normal diesel engine running on diesel fuel.

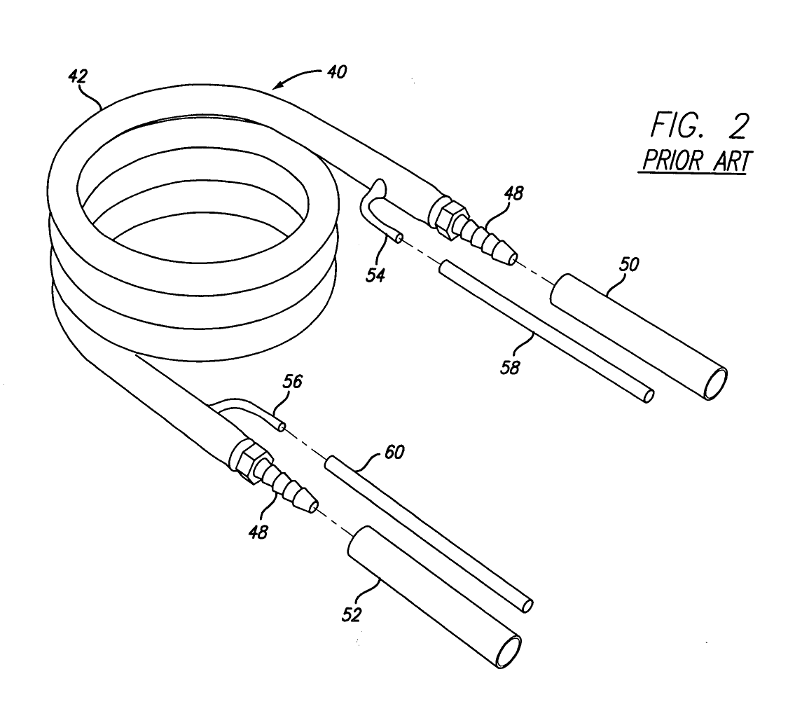

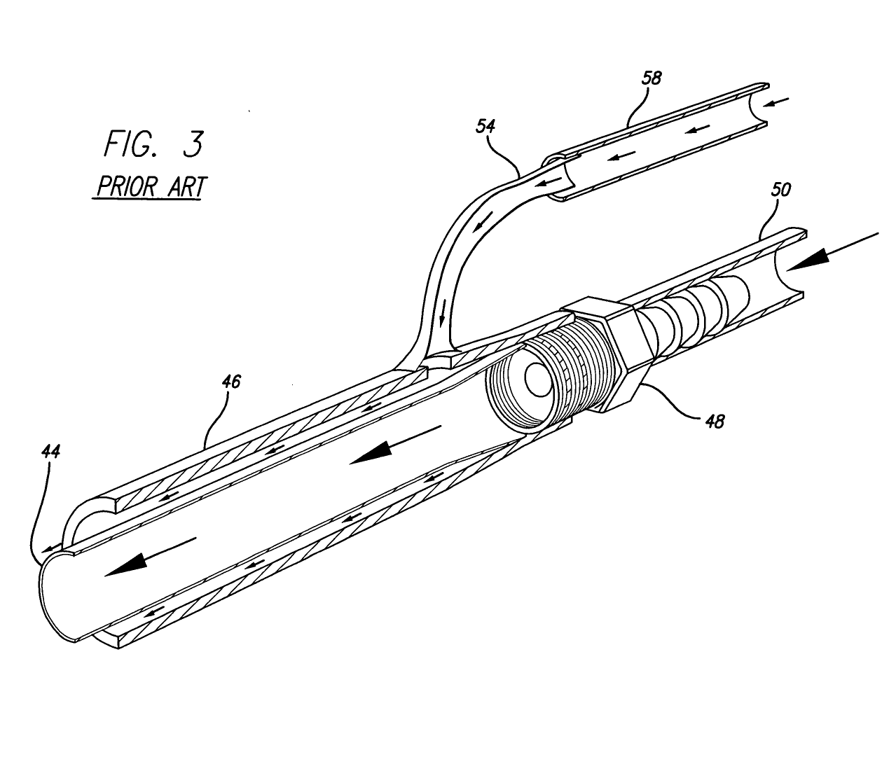

FIGS. 2 and 3 are illustrate one example of a fuel heater 40 of the prior art used in diesel conversions to heat alternative fuels such as vegetable oils. It consists of a coil 42, having an outer conduit 46, and concentrically an inner conduit 44. The outer conduit 46 has a fuel input port 54 and a fuel output port 56 which are attached to fuel input line 58 and fuel output line 60 respectively. The inner conduit 44 has engine coolant input and output connectors 48 connected to engine coolant input line 50 and engine coolant output line 52. As is common with prior art conversions a heater of this kind must be mounted with customized mounting gear in order to be close to the injector pump and requires rerouting of the fuel lines.

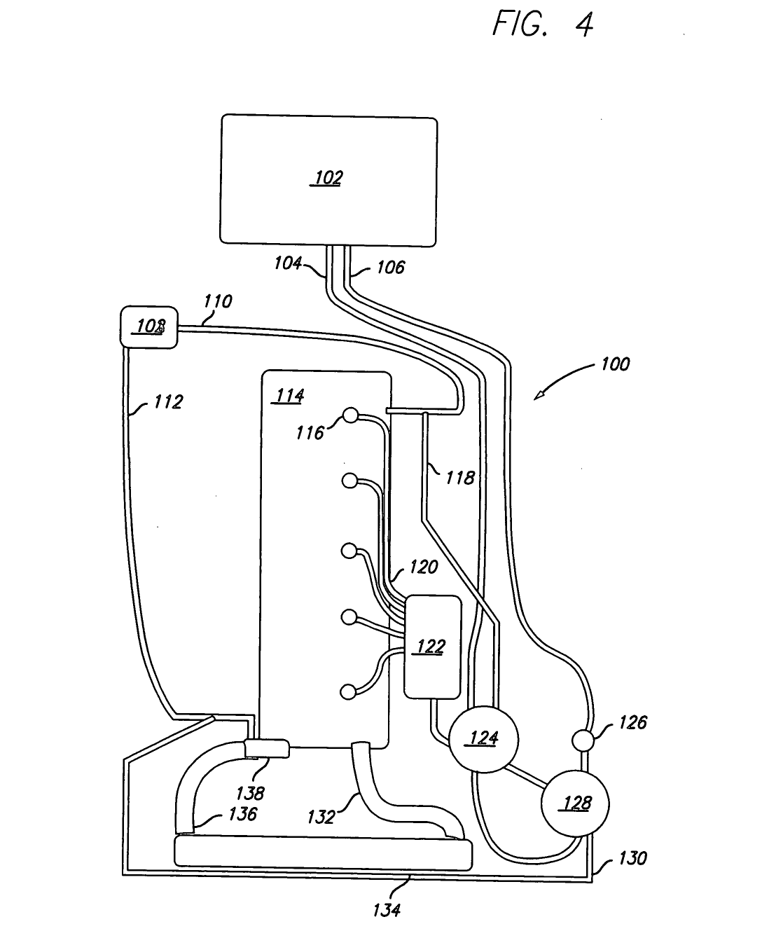

FIG. 4 is a generic schematic diagram of a converted diesel engine system 100 in which the present invention is implemented. The parts are;
Fuel tank, 102,
Fuel return line, 104,
Fuel line to engine, 106,
Heater core, 108,
Heater hose, 110,
Heater hose, 112,
Engine, 114,
Fuel Injectors (5), 116,
Heater hose to/from exchanger, 118,
Fuel lines to injectors, 120,
Injector pump, 122,
Heat exchanger, 124,
Electric fuel pump, 126,
Filter assembly, 128,
Heater hose to filter assembly, 130,
Radiator hose, 132,
Radiator, 134,
Radiator hose, 136,
Water pump, 138.

The fact that the present invention allows the use of the stock filter mount and avoids any rerouting of fuel lines or mounting of a fuel heater is an important part of the method of the present invention as will be seen, because it renders simplicity and low cost to the conversion; it massively simplifies the conversion process and system.

The conversion method comprises substituting for the stock filter a heater so that the fuel will flow through the heater to the injector pump. Such a heater is described below.

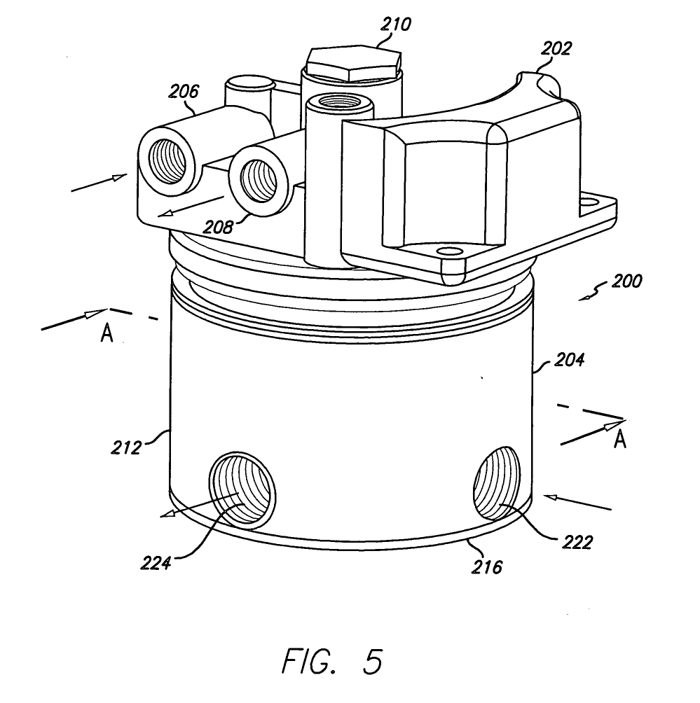

Referring now to FIGS. 5,6,7 and 10 an embodiment of the heat exchanger of the invention is described. In this embodiment engine coolant is used as the heat source. The apparatus 200 uses the stock filter mount 202 on which the heat exchanger 204 is mounted. The stock filter mount 202 has fuel-in and fuel-out ports at 206 and 208 respectively. When in use as stock, a stock fuel filter is attached below the stock filter mount, attached in the well known manner by way of the hollow bolt 210 which also serves as part of the fuel-out porting. The hollow bolt 210 is also used in the present invention, and it performs the same function as it did originally to retain the stock filter, in this case to retain the heat exchanger and for fuel-out porting.

The heat exchanger 204 has a heat exchanger body 212 having a fuel heating chamber 214 and a heat transfer portion 216. A high heat transfer rate surface 218 is between the fuel heating chamber 214 and the heat transfer portion 216 so as to rapidly transfer heat to the fuel in the heat transfer chamber 214 from the heat transfer portion 216. The heat transfer surface 218 is configured with concentric ridges 220 to have increased surface area inside the heat transfer chamber 216, so as cause rapid heat transfer. The heat transfer portion 216 has a coolant-in port 222 and a coolant-out port 224, receiving coolant from a coolant-in line 226 and delivering it to a coolant-out line 228, the latter being diverted from and sent back to the coolant system. The heat exchanger body 212 is preferably made from a single piece, machined to the configuration shown, and preferably of a high heat exchange rate material such as aluminum, in order to allow a high heat exchange rate through the heat transfer surface 218. It could be surrounded by an insulating material if desired.

In order to mount the heat exchanger 204 to the stock filter mount 202 an adapter element is provided that will be attached to or made integrally as a part of the heat exchanger body and that is configured to have passages that will allow fuel from the stock filter mount fuel-in port 206 to flow into the fuel heating chamber 214, and will allow heated fuel to flow from the fuel heating chamber 214 into the fuel-out port 208. The adapter element will be able to mount on the stock filter mount 202 in a manner at least analogous to the way a stock filter mounts so as to facilitate flow of fuel into and out of the fuel heating chamber 214.

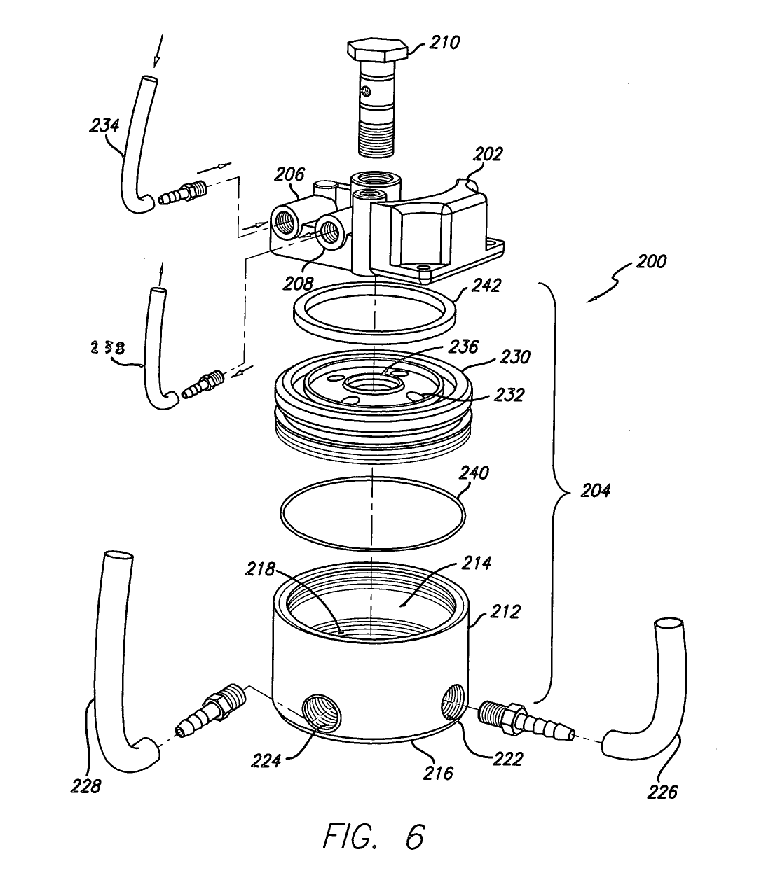

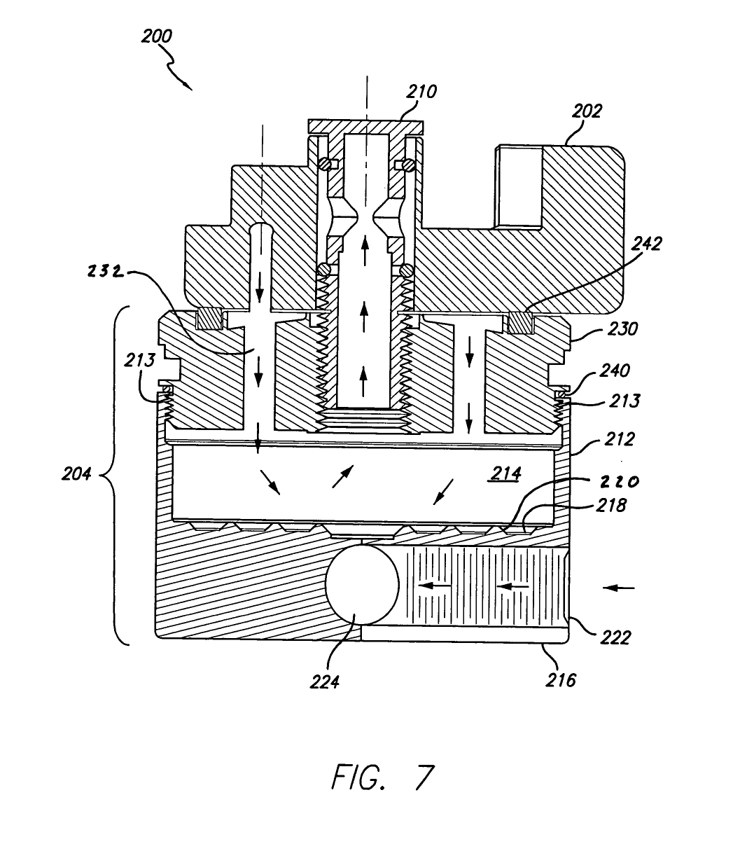

Referring to FIGS. 6 and 7, a preferred adapter element is an adapter plate 230 that is fixed to the top of the heat exchanger body 212, as shown by threads, although any convenient means of mounting it to the heat exchanger body 212 can be used. The adapter plate 230 mimics the top of a stock filter so as to provide fuel-in passages 232 in communication with the fuel-in port 206 which receives fuel from a stock fuel-in line 234. The fuel flow is shown by arrows. The adapter plate 230 has a threaded central hole 236 to engage the threaded hollow bolt 210 by means of which the assembly is fitted in place in the same manner as the stock filter which it replaces. Fuel in the fuel heating chamber 214 exits through the hollow bolt 210 to the fuel-out port 208 and is then directed into the engine via a stock fuel-out line 238.

An O-ring 240 seals the adapter plate 230 when threaded to the heat exchanger body 212 by threads 213 and an O-ring or sealing washer 242 seals the heat exchanger body 204 to the stock filter mount 202.

In use as part of a conversion kit installation, the heat exchanger 204 is installed on the stock filter mount 202, with coolant-in line 226 and coolant-out line 228 fitted as shown. The fuel-in and fuel-out lines remain as stock installations.

In operation, hot coolant flowing into and out of the heat transfer portion 216 will transfer heat into the heat transfer portion 216 which will transfer into the fuel passing through the fuel heating chamber 214.

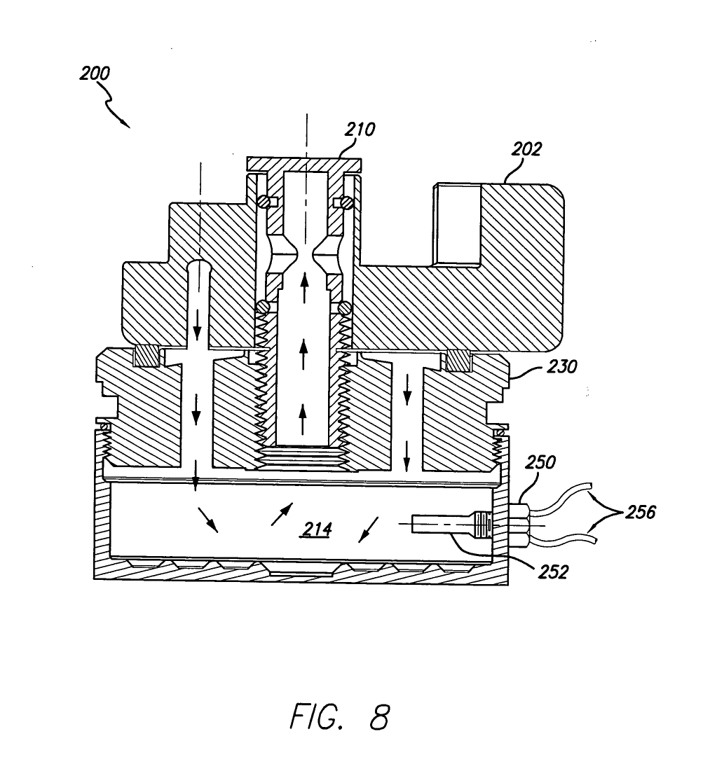

An alternative embodiment is shown in FIG. 8 which uses an electrical heat source. In this embodiment a heat element 250 in the form of a transducer is mounted in the wall of the fuel heating chamber 214, its heating rod 252 being in the fuel and with wiring 256 to the source of electricity from the battery and the alternator.

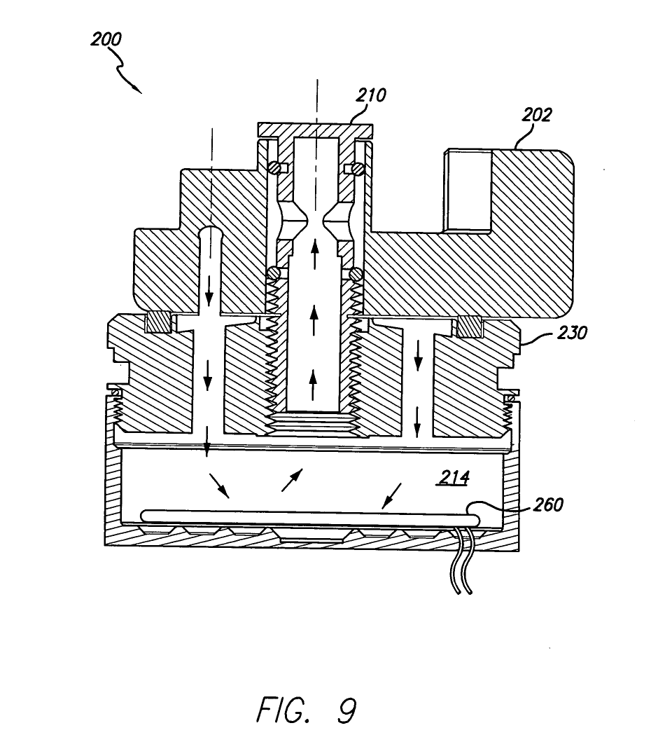

In a further embodiment as shown in FIG. 9, a coil heater 260 is fitted at the bottom of the fuel heating chamber 214 having electrical heating coils that are connected to a source of electricity.

Although the best mode contemplated by the inventor of carrying out the present invention is disclosed above, practice of the present invention is not limited thereto. It will be apparent that various additions, modifications and rearrangements of the features of the present invention may be made without deviating from the spirit and scope of the underlying inventive concept.

Moreover, the individual components need not be formed only in the disclosed shapes, or assembled only in the disclosed configuration, but could be provided in any shape or configuration which operate together so as to provide the heating of fuel in an assembly that is attached to the stock filter mount.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. This disclosure has been made with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . .” and no method or process step herein is to be construed under those provisions unless the step, or steps, are expressly recited using the phrase “step(s) for . . . ”

1. A method of conversion for a diesel engine to run on alternative fuel comprising;
substituting for the stock fuel filter by mounting on the stock filter mount a heat exchanger having a fuel heating chamber adapted to receive incoming fuel from the stock fuel-in line in the filter mount and to exit outgoing fuel to the stock fuel-out line in the filter mount and a heat source in close proximity to the fuel heating chamber;
whereby heat from the heat source is transferred to the fuel flowing through the fuel heating chamber.

2. The method of claim 1 wherein the heat source is a heat transfer chamber adjacent to the heat transfer chamber having engine coolant flowing through it;
whereby heat from the engine coolant flowing through the heat transfer chamber is transferred to the fuel flowing through the fuel heating chamber.

3. The method of claim 1 wherein the heat source is an electrical heater.

4. The method of claim 1 further comprising providing an adapter plate between the stock filter mount and the fuel heating chamber, the adapter having a configuration that mimics the configuration of the fuel flow passages of a stock filter to provide a flow path for incoming fuel into and for outgoing fuel out of the fuel heating chamber in flow communication with the stock fuel-in line and the stock fuel-out line of the stock filter mount.

5. The method of claim 1 further comprising installing a booster fuel pump in the fuel line upstream of the heat exchanger.

6. The method of claim 2 further wherein the heat exchanger comprises a high heat transfer rate member between the fuel heating chamber and the heat transfer chamber.

7. The method of claim 3 wherein the source of electrical heating is a transducer installed in the fuel heating chamber.

8. The method of claim 3 wherein the source of electrical heating is a heating transducer in a heat transfer portion adjacent to the fuel heating chamber.

9. The method of claim 8 wherein the heating transducer is a heating coil.

10. A heat exchanger for use in heating alternative fuel in a conversion for operating a diesel engine on alternative fuel comprising;
a fuel heating chamber;
an adapter element mounted on the fuel heating chamber and being mountable to the stock filter mount of a diesel engine system, said adapter element having at least one passage for allowing incoming fuel from the stock filter mount fuel-in port to flow into the fuel heating chamber and having passages for allowing outgoing fuel from the fuel heating chamber to flow into the stock filter mount fuel-out port;
a heat source in close proximity to the fuel heating chamber;
a source of heat into the heat transfer portion;
whereby heat from the heat transfer portion will heat the fuel flowing through the fuel heating chamber.

11. The heat exchanger of claim 10 wherein the adapter element is an adapter plate between the stock filter mount and the fuel heating chamber, the adapter plate having a configuration that mimics the configuration of the fuel flow passages of a stock filter to provide a flow path for incoming fuel into and for outgoing fuel out of the fuel heating chamber in flow communication with the stock fuel-in line and the stock fuel-out line of the stock filter mount.

12. The heat exchanger of claim 10 wherein the heat source is a heat transfer chamber adjacent to the fuel heating chamber adapted to have engine coolant flowing through it; whereby heat from the engine coolant flowing through the heat transfer chamber is transferred to the fuel flowing through the fuel heating chamber.

13. The heat exchanger of claim 10 wherein the heat source is an electrical heater.

14. The heat exchanger of claim 10 further comprising a booster fuel pump in the fuel line upstream of the heat exchanger.

15. The heat exchanger of claim 12 further comprising a high heat transfer rate member between the fuel heating chamber and the heat transfer chamber.

16. The heat exchanger of claim 13 wherein the source of electrical heater is a transducer installed in the fuel heating chamber.

17. The heat exchanger of claim 13 wherein the source of electrical heater is a heating transducer in a heat transfer portion adjacent to the fuel heating chamber.

18. The heat exchanger of claim 17 wherein the heating transducer is a heating coil.

19. A heat exchanger for use in heating alternative fuel in a conversion for operating a diesel engine on alternative fuel comprising;
a fuel heating chamber;
means for mounting the heat exchanger to the stock filter mount of a diesel engine system for allowing incoming fuel from the stock filter mount fuel-in port to flow into the fuel heating chamber and for allowing outgoing fuel from the fuel heating chamber to flow into the stock filter mount fuel-out port;
a heat source in close proximity to the fuel heating chamber;
a source of heat into the heat transfer portion;
whereby heat from the heat transfer portion will heat the fuel flowing through the fuel heating chamber.

20. The heat exchanger of claim 19 wherein the heat source is a heat transfer chamber adjacent to the fuel heating chamber adapted to have engine coolant flowing through it; whereby heat from the engine coolant flowing through the heat transfer chamber is transferred to the fuel flowing through the fuel heating chamber.
